(19) United States
(12) Patent Application Publication
(10) Pub. No.: US 2008/0311874 A1
(43) Pub. Date: Dec. 18, 2008

(54) Antenna Diversity Device

(76) Inventor: Markus Hoffmeister, Salzgitter (DE)

Correspondence Address: KENYON & KENYON LLP, ONE BROADWAY, NEW YORK, NY, 10004, US

(21) Appl. No.: 11/794,279

(22) PCT Filed: Nov. 22, 2005
(86) PCT No.: PCT/EP05/56140

§ 371 Date: Jun. 11, 2008

(30) Foreign Application Priority Data
Dec. 23, 2004 (DE) 10-2004-062-000.8

(51) Int. Cl. H04B 7/08

(52) U.S. Cl. 455/275

(57) ABSTRACT

In an antenna diversity device, at least one of the receive bands of the diversity antennas is frequency converted on the antenna side in such a way that the receive bands in the frequency spectrum are next to one another. This enables the diversity signals to be transmitted via a shared transmission medium to the receiver.

### BACKGROUND INFORMATION

In diversity antenna systems, the individual antenna signals are supplied to an analyzer circuit for evaluation of the receive quality of the signals. The sum signal of all diversity antenna signals or the strongest individual signal is supplied to the receiver (German Patent No. DE 101 09 359).

### SUMMARY OF THE INVENTION

According to the present invention, by implementing a frequency conversion on the antenna side converting the at least one receive band of an antenna in such a way that the receive bands are next to one another in the frequency spectra of the diversity antennas, it is possible to transmit a plurality of diversity antenna signals via a shared transmission medium, a coaxial cable in particular.

Previously, the antenna signal of each antenna was supplied to the receiver via a separate cable. In the present invention, only one coaxial cable is needed.

The additional complexity is not excessive. Although a frequency converter and a diplexer are needed on the antenna side, if the local oscillator signal of the receiver, which may advantageously also be transmitted in the opposite direction of the signals of the diversity antennas via the antenna lead, is preferably used for conversion, the frequency of the signal already converted on the antenna side no longer needs to be converted in the receiver. It may be directly converted into the required intermediate frequency position on the antenna side.

### BRIEF DESCRIPTION OF THE DRAWING

FIG. 1 shows a block diagram of the present invention.

### DETAILED DESCRIPTION

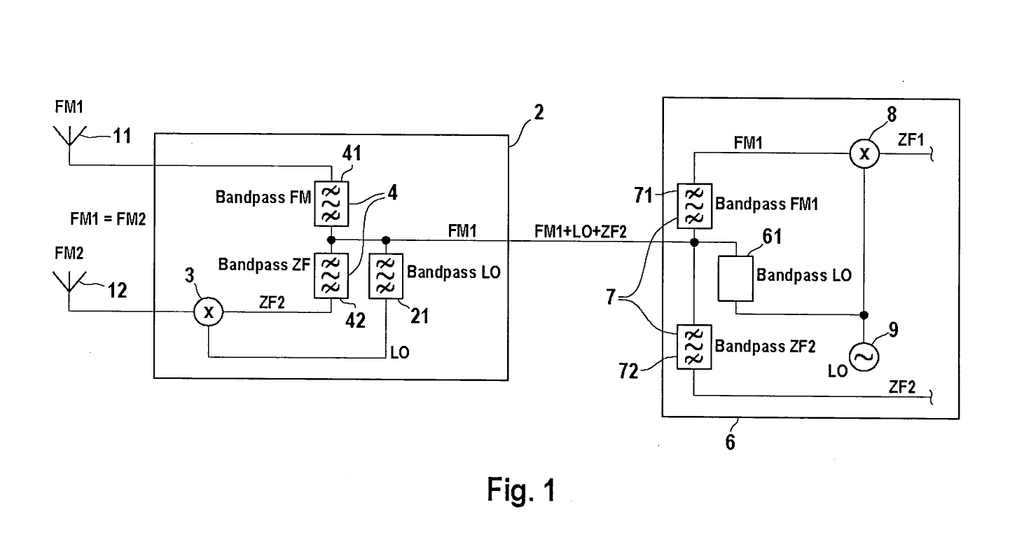

As FIG. 1 shows, two antennas 10 and 11 are provided for an antenna diversity operation. Of course, the diversity operation and the use of the principle according to the present invention may also be carried out using more than two antennas. The receive bands of the antennas are labeled FM1 and FM2. In antenna diversity operation, the receive bands are the same. FM1 and FM2 are only differentiated in order to make it clear from which antenna the particular receive signal is coming (FM1 from antenna 11 and FM2 from antenna 12). The levels of the receive signals may of course differ, which is exactly why diversity analysis is useful.

Provided on the antenna side is unit 2 which is used to convert at least one of the receive bands FM1 or FM2 in such a way that the frequency bands of the diversity antenna are next to one another in the frequency spectrum, i.e., their frequencies do not overlap or only insignificantly overlap. In the exemplary embodiment, receive band FM2 of antenna 12 is converted into intermediate frequency position ZF2 by mixer 3. Unconverted signal FM1 is joined with converted signal ZF2 via diplexer 4 and jointly transmitted via transmission medium 5, preferably a coaxial cable, to receiver 6 or a diversity signal analysis, which may be located outside or integrated into receiver 6. Diplexer 4 includes a band pass 41 for signal FM1 and a band pass 42 for signal ZF2. In receiver 6 the signal is split again into individual signals FM1 and ZF2 by the corresponding band filters 71 and 72 via diplexer 7. Signal ZF2 may be further processed in receiver 6 without further conversion if the mixing frequency for mixer 3 is appropriately selected. In receiver 6 signal FM1 is converted into regular intermediate frequency position ZF1 via mixer 8. Output signal LO of local oscillator 9 is used as the mixing frequency of mixer 8.

Using output signal LO of local oscillator 9 as the mixing frequency for mixer 3 is particularly advantageous. For this purpose, signal LO is fed into coaxial cable 5 via band pass 61 in the opposite direction of that of signals FM1 and ZF2 picked up from antennas 11 and 12, processed by unit 2, and transmitted to receiver 6. The LO signal is filtered on the antenna side via band pass 21 and is available to mixer 3 as a mixing signal.

In the case of more than two antennas, the additional signals may also be converted without major complexity, so that their frequency is located next to that of the other diversity signals in the frequency spectrum. The conversion frequencies required therefor are derived in a simple manner from the LO signal by division or multiplication. Frequency is advantageously divided/multiplied first in unit 2 to limit the filter complexity. Additional filters/band pass devices may then possibly be needed.

The filter, i.e., band pass 42 for the intermediate frequency has a fixed frequency. If the intermediate frequency is selected appropriately, for example, 30 MHz, i.e., for an FM frequency of 88 to 108 MHz and an LO frequency of 78 to 58 MHz, this is also true for the filters, i.e., band pass 41, for FM and band passes 21 and 61 for LO. If the intermediate frequency is selected to be lower, for example, 10 MHz as typically used today, i.e., for an FM frequency of 88 to 108 MHz and an LO frequency of 98 to 78 MHz, the corresponding filters must be tunable.

1-6. (canceled)

7. An antenna diversity device comprising:
a plurality of diversity antennas;
a shared transmission medium; and
a frequency converter situated on an antenna side which converts at least one receive band of at least one of the diversity antennas in such a way that receive bands of the diversity antennas are next to one another in a frequency spectrum and are transmissible via the shared transmission medium.

8. The device according to claim 7, wherein the shared transmission medium includes a coaxial cable.

9. The device according to claim 7, wherein one diversity antenna signal, together with another frequency-converted diversity antenna signal, is supplied without additional frequency conversion to the shared medium via a diplexer.

10. The device according to claim 7, wherein at least one of (a) a local oscillator signal of a receiver connected to the shared medium and (b) a signal derived from it is provided for frequency conversion.

11. The device according to claim 10, wherein the local oscillator signal is suppliable to the shared medium in a direction opposite to that of signals of the diversity antennas.

12. The device according to claim 7, wherein an intermediate frequency conversion of only an antenna diversity signal that has not already been subjected to a frequency conversion on the antenna side is provided on a receiver side.

13. The device according to claim 10, wherein the plurality of diversity antennas includes at least three diversity antennas, and wherein, for each additional receive band to be converted on an antenna side, a corresponding conversion frequency is derived from the local oscillator signal of the receiver, via one of frequency division and multiplication.
